(19) United States
(12) Patent Application Publication
(10) Pub. No.: US 2004/0267786 A1
(43) Pub. Date: Dec. 30, 2004

(54) Method and apparatus for processing periodically recurring or consecutive treatments for a patient using a data record which includes therapeutic information items

(76) Inventors: Klaus Abraham-Fuchs, Erlangen (DE); Eva Rumpel, Erlangen (DE); Sven Tiffe, Wien (AT)

Correspondence Address: HARNESS, DICKEY & PIERCE, P.L.C., P.O.BOX 8910, RESTON, VA, 20195, US

(21) Appl. No.: 10/849,020

(22) Filed: May 20, 2004

(30) Foreign Application Priority Data
May 20, 2003 (DE) 10322683.4

(51) Int. Cl. G06F 17/00

(52) U.S. Cl. 707/100

(57) ABSTRACT

A method relates to at least one of periodically recurring and consecutive treatments for a patient using a data record including a therapeutic information item. The method includes using therapeutic information items, stored in the data record, to identify at least one periodicity criterion. The method further includes using the identified at least one periodicity criterion to ascertain a subsequent treatment.

The present application hereby claims priority under 35 U.S.C. §119 on German patent application number DE 103 22 683.4 filed May 20, 2003, the entire contents of which are hereby incorporated herein by reference.

### FIELD OF THE INVENTION

The invention generally relates to a method for processing periodically recurring or consecutive treatments for a patient using a data record which includes therapeutic information items. The invention also generally relates to an apparatus and a computer program product for carrying out the method.

The data record is subsequently referred to itself as a therapeutic information item for short. The data record includes therapeutic information items as data items.

### BACKGROUND OF THE INVENTION

In general, a database stores a plurality of data records for various therapeutic information items associated with one or more patients in the style of an electronic patient record (also called EPR for short). In this context, the electronic patient record may, be distributed over databases in a plurality of institutions in the health service, e.g. for a plurality of treating doctors or hospitals.

When a patient is treated, it may be that the same or a plurality of treatments for various clinical pictures or from various doctors are demanded or requested at the same or different periodic intervals. In this context, different clinical pictures, which are frequently handled by different specialist doctors, may result in multiple examinations of the same kind. This leads to high treatment costs and is furthermore also frequently associated with an enormous expenditure of time for the patient.

To solve these problems of multiple prescriptions of the same kind and resultant parallel treatments of the same kind, no automatically executable methods have been disclosed in the prior art to date to the best of the applicant's knowledge. In addition, the widespread use of therapeutic information items (=patient data items) stored in electronic form and networked access thereto are just starting to appear in medicine.

### SUMMARY OF THE INVENTION

An embodiment of the invention includes an object of reducing or even avoiding unnecessary and multiple treatments of the same kind for a patient, particularly of optimizing periodically recurring or consecutive treatments.

A method is for processing periodically recurring or consecutive treatments for a patient using a data record which includes therapeutic information items involves therapeutic information items stored in the data record being used to identify at least one periodicty criterion which is used to ascertain a subsequent treatment.

In this context, a treatment is understood to mean a succession of diagnostic examinations and/or therapeutic measures which may in turn be divided into single treatment steps. A treatment step may thus in turn be a diagnostic examination or a therapeutic measure. To simplify matters, the text below refers only to treatments or to a succession of treatments.

In this case, a data record including therapeutic information items includes, in its most general form, a collection of data items, such as patient data items and/or data items relating to therapies or examinations which have already been carried out and/or are yet to be carried out and/or general data items such as data relating to diagnostic and/or therapeutic means. In this context, a treatment may be an examination on the patient and/or a therapy which is to be carried out on the patient. A frequent component of a therapeutic information item in this context is, by way of example, a treatment, particularly an examination, an associated time, e.g. a date on which the treatment, i.e. in this case the examination, has been performed or is intended to be performed.

Times of execution, stored as data items, for examinations or therapies during a succession of treatments are now advantageously used to identify a periodicity criterion which is used to ascertain the subsequent treatment. Alternatively or in addition, other data having a periodic character or time character—such as a number of requisite aftercare examinations or parallel examinations—may be used to ascertain an associated periodicity criterion, such as weekly, monthly or half-yearly cycle for periodically recurring treatments or agreed examination appointments. In other words: the periodicity criterion may in this case be, by way of example, an algorithm which uses a parameter, such as “weekly”, “monthly”, “annually”, to describe regularly occurring treatment steps in a succession of treatments or a list of appointments for periodically recurring or consecutive treatments (also called treatment steps).

In addition, the data record for a therapeutic information item may be linked to a further data record for a therapeutic advice item. In this case, the data record for a therapeutic advice item comprises, in its most general form, a collection of data items—such as input and/or output variables for therapeutic information items and a number of expert rule—which are used to generate a therapeutic advice item on the basis of therapeutic information items, e.g. using patient data items and/or using data items relating to available diagnostic and/or therapeutic method/device/etc., with the aid of the expert rules.

The therapeutic information items are provided for the purpose of generating the therapeutic advice item in the form of input or user data items. In addition, generated therapeutic advice items are used to store corresponding data items, such as the number of requisite preventive and/or aftercare examinations in the therapeutic information items. In other words: data records comprising therapeutic advice items and data records comprising therapeutic information items are linked to one another by means of appropriate references.

An embodiment of the invention is based on the insight that the use of modern information and communication technology is currently being greatly expanded in the health service. The use of electronic data processing in hospitals (e.g. HIS=Hospital Information System, RIS=Radiology Information System, PACS=Picture Archive & Communication System, LIS=Laboratory Information System) and in doctor's practices (practice management software, electronic patient records) is becoming more and more common. A subsequent development step is generally expected to network this software and these databases across the institutions in the health service (clinics, doctor's practices, therapeutic practices etc.). This provides the option of a “networked health service”, at first at national or regional level and later globally. This development provides the basis for use of the two aspects of the invention.

An advantage of an embodiment of the invention and its refinements is, in particular, that entire treatment processes with individual treatment sequences can be checked and monitored for periodically recurring or consecutive treatment steps.

Expediently, newly input therapeutic information items are used to identify at least one periodicity criterion. This allows automatic and immediate recognition of periodically recurring treatments and/or of treatments which are close in time for a patient which possibly each require the same examination results as prerequisites, so that firstly periodically recurring, but also consecutive, treatments needing to be carried out for various clinical pictures can be optimized such that the number of examinations and/or therapeutic measures to be performed is minimized. By way of example, a respective blood examination may be required for a plurality of treatments for a patient, which means that the number of times that blood is taken when treatments are close together in time can therefore be reduced in the most favorable case to a single instance of blood being taken.

In another preferred embodiment of the method, the periodicity criterion is used to ascertain an associated time of execution for the next treatment. This allows automatic monitoring and checking of treatments to be performed on a patient. By way of example, this automatically allows appointments made for treatments which are a long way ahead to be managed particularly easily, for example for preventive and/or aftercare examinations, and to be handled automatically.

Expediently, a common subsequent time of execution is ascertained for a plurality of periodically recurring or chronologically consecutive treatments using the respective associated periodicity criterion. This ensures that a plurality of examinations or therapeutic measures in the style of a visit are performed for a patient during a single treatment.

In another advantageous embodiment, at least one previous treatment and its associated therapeutic information items are ascertained for the subsequent treatment. Depending on the type and time of the recording of the therapeutic information items for the previous treatment, these may be used for the subsequent treatment, for example, so that a repeat input of these therapeutic information items or repeat recording and any examination which may be required in this regard are safely avoided. This saves both cost and time.

Advantageously, the requisite examination results associated with the subsequent treatment are ascertained, with the therapeutic information items associated with the previous treatment being used to identify previous examination results corresponding to the requisite examination results. Preferably, if requisite examination results are the same as previous corresponding examination results, this involves the latter being used instead of reascertaining requisite examination results. In other words: previous examination results which are also required for the subsequent treatment are used again. This safely avoids rerecording.

Expediently, the subsequent treatment is used to output a report. By way of example, depending on the type and use of the method when automatically identifying the subsequent treatment, a report in the form of an electronic message is output, for example to the treating general practitioner and/or to other treating specialist doctors or clinic doctors. Alternatively or in addition, the subsequent treatment is used to output a report for the previous treatment.

By way of example, this involves the output of a report to the doctor who prescribed the previously treatment in the form of a notification, e.g. in the form of an electronic message. Alternatively or in addition, the requisite examination results are used to output a report. This allows, by way of example, a report in the form of an electronic message from the doctor collecting the requisite examination results to be output to the doctor prescribing the treatment, if the latter is a different doctor.

In another alternative or additional embodiment of the method, ascertained examination results are used to output a report. Preferably, a report is output when a threshold value for at least one examination result is exceeded and/or undershot. If a critical value is exceeded for a blood examination, for example, then a report can be automatically output to the treating doctor upon identification of the fact that a threshold value has been exceeded and/or undershot.

Expediently, examination results required for the respective treatment are recorded locally and/or centrally. By way of example, the examination results are ascertained locally in a laboratory and may be forwarded from there to an institute or to a treating doctor. In addition, the examination results recorded for the treatment are preferably stored locally and/or centrally. In this case, the examination results are stored, by way of example, with the treating general practitioner or specialist doctor and/or centrally in an archive in a clinic, so that a plurality of specialist doctors can access the requisite examination results. In addition, the treatments—previous and/or subsequent—are also stored centrally and/or locally for the purpose of documentation which is as accurate, safe and permanent as possible.

For safe and fast identification of treating doctors, the respective treatment is preferably assigned at least one user, for example the treating doctor and/or the implementing laboratory. The association between the user and the treatment in question may preferably be used to forward the examination results ascertained for the treatment to the user automatically. In addition or alternatively, the respective treatment may also be assigned a number of basic data items. Preferably, the basic data items stored in this case are at least examination results, time of execution and/or execution period.

In respect of the apparatus for carrying out the method described above, an embodiment of the invention may achieve an object by providing a computer on which the method is implemented via a computer program product. To exchange information, such as examination results, or to forward reports, this arrangement preferably has a plurality of computers, for example a plurality of computers associated with the respective doctor and/or a laboratory, networked to one another or in a communication connection. Alternatively, the apparatus may include a plurality of computers which are networked in a clinic and have a computer program product for carrying out the method.

### BRIEF DESCRIPTION OF THE DRAWINGS

A non-limiting exemplary embodiment of the invention is explained in more detail below with reference to the drawings, in which:

FIG. 1 shows a schematic illustration of the software implementation of a data record which includes at least one therapeutic information item, and

FIG. 2 shows a schematic illustration of a variant of the therapeutic information item shown in FIG. 1.

Mutually corresponding parts are provided with the same reference symbols in all figures.

### DETAILED DESCRIPTION OF THE PREFERRED EMBODIMENTS

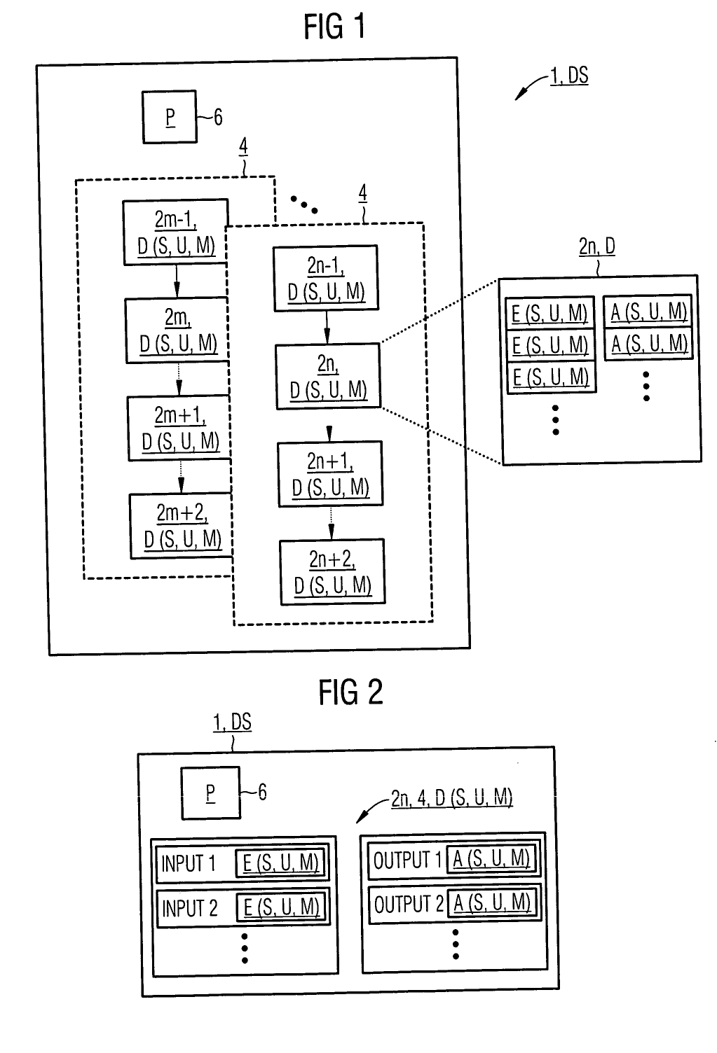

FIG. 1 schematically shows a data record DS which includes therapeutic information items 1 and is managed by a medical institution, i.e. in a doctor's practice or in a clinic, for example, for each patient or possibly for a group of patients. Such a data record DS including therapeutic information items 1 is also referred to as a therapeutic information item 1 below for short. A customary form of therapeutic information item 1 is an electronic patient record.

In specific cases, the therapeutic information item 1 may also extend to physically distributed databases. What is more important below, however, is the layout of such a therapeutic information item 1 and the respectively stored and interlinked information items, rather than the specific storage location of individual or all information items or data items.

In this case, the data record DS associated with a respective therapeutic information item 1 or electronic patient record stores appropriate data items D for documenting medical treatments 2n, 2n+1, . . . , 2n+2 (subsequently called 2n for short). If required, data items D relating to the start, relating to the previous duration, relating to the probable or actual end of the respective medical treatment 2n on the patient are stored. For accurate and safe documentation of the medical treatment 2n, the therapeutic information item 1 includes, as data items D, firstly descriptions or lists of symptoms S, measured values M or examination results U and the like, and secondly also therapeutic measures and medications and the like.

In other words: a treatment 2n is subsequently understood to mean a diagnostic examination and/or therapeutic measure which may respectively be divided in turn into individual treatment steps. A treatment step may thus in turn be a diagnostic examination or a therapeutic measure. To simplify matters, only treatments 2n are referred to below.

Each individual treatment 2n is stored in a succession of treatments 4. The succession of treatments 4 is, by way of example, a “concatenated list” of periodically recurring or chronologically consecutive treatments 2n of different kinds, with each list element being formed by a treatment 2n. Using the succession of treatments 4, treatments 2n−1 which are in the past and thus previous may also continue to be documented using the data items D. In addition, it is possible to reconstruct the historical development of the respective treatment 2n−1, 2n, 2n+1 at any time.

So that, when there are a plurality of periodically recurring or chronologically consecutive treatments 2n, they can be optimized and the patient can be prevented from being burdened by multiple examinations for treatments 2n of essentially the same kind, the data items D associated with the therapeutic information item 1 are used to ascertain at least one periodicity criterion P which is taken as a basis for ascertaining a subsequent treatment 2n+1. To this end, the data record DS in question is examined for data items D having a periodic character or a time character, for example for a time of execution (=appointment or start of one of the treatments 2n, 2n+1).

Alternatively or in addition, new entries, e.g. input data items E which are to be entered in the therapeutic information item 1, such as a prescription from a doctor and/or output data items A from a previous treatment 2n−1, are used for automatically ascertaining a periodicity criterion P. The periodicity criterion P ascertained is then used to identify an associated time of execution for the subsequent treatment 2n+1. In this context, periodicity criterion P is understood to mean an algorithm which uses a parameter in the data record DS, such as “weekly”, “monthly”, to describe a regular occurrence of a treatment 2n or of a treatment step in a succession of treatments 4.

By way of example, this is done by using the “software agents” 6 to examine the therapeutic information item 1 (=electronic patient record), which is frequently physically distributed over various computers, for the times of execution of subsequent treatments 2n+1, 2n+2 (called 2n+1 below for short) by virtue of a plurality of future subsequent treatments 2n+1 being compared with one another for examinations which are of the same kind or are the same, for example in the manner of a pattern of examination periods or examination intervals, i.e. time of execution and time interval.

The task of software agents 6 is to find the periodic occurrence of treatments 2n in the data record DS and then to check them to determine whether the same treatment 2n also arises periodically. If so, the software agent 6 will optimize the appointments for the individual treatments 2n such that as few medical examinations and/or therapeutic measures as possible need to be performed. The subsequently described methods for identifying periodically recurring treatments 2n and subsequent treatments 2n+1, 2n+2 are carried out using software agents 6.

In this case, the software agents 6 are software modules which autonomously and thus automatically take the periodicity criterion P as a basis for searching the electronic patient record in a separate data record DS or in a data record DS which is distributed over a plurality of databases in a data network for information items or data items D in the data record DS. As a result of this, as described above, periodically recurring and/or chronologically consecutive treatments 2n are optimized in terms of avoiding multiple examinations.

By way of example, subsequent treatments 2n+1 determined on the basis of a diagnosis, particularly examinations and/or therapeutic measures, need to be performed on a half-yearly basis in January and July, and a different diagnosis necessitates further subsequent treatments 2m+1, for example quarterly examinations in February, May, August and November. So as firstly to relieve the burden on the patient and secondly also to save costs, it is therefore possible in this case to optimize the examinations or therapeutic measures for both treatments 2n+1 and 2 m+1 such that they are checked for similarity, particularly for examinations which are identical as possible. This ensures that, although the various diagnoses have been assigned subsequent treatments 2n+1 and 2 m+1 independently of one another, they are additionally examined and checked for a common time of execution once the presence of identical examinations or similarity has been identified.

By way of example, when examinations of the same kind are identified, the quarterly examinations are deferred by one month, so that they concur with the half-yearly examinations and only examinations in January, April, July and September are now performed. To this end, a software agent in question in the form of an algorithm includes time functions, particularly quotients, intervals, minimum time intervals and the like which can be used to check the data items D in the data record DS for similarity or for values within a tolerance range.

During each treatment 2n and/or 2m, new data items D, e.g. symptoms S and examination results U, may be collected in the process. These data items D may be input or output and stored as input and output data items E or A for the respective treatment 2 in the data record D associated with the therapeutic information item 1, either directly or indirectly, i.e. using referencing for the actual output location or storage location.

As a result, for example if the same output data items A are recurrently generated in a plurality of consecutive treatments 2n and/or 2m or if the same or at least partly the same input data items E are recurrently recorded, it is possible to prevent multiple entries by virtue of the same input or output data items E, A repeatedly referencing a storage location with the same input or output data item E or A in each case. In other words: for the subsequent treatment 2n+1 and/or 2m+1, at least one of the previous treatments 2n−1 and/or 2m−1 and its associated data items D, particularly its examination results U, are ascertained, with the data items D being able to be taken as a basis for reusing examination results U which are already available from a previous treatment 2n−1 and/or 2m−1 as examination results for the subsequent treatment 2n+1.

Since, depending on the degree and scope of the documentation of the respective medical treatment 2n and/or 2m, the number of input data items E available and/or the number of output data items A may vary, it is additionally possible to store the input data items and/or the output data items E and A in an input or output data list (not shown), for example, particularly in the form of concatenated list. This allows dynamic, demand-related provision of storage space for precisely as many input and output data items E and A as need to be available and are generated during the specific treatment 2n.

The data structure of the therapeutic information item 1 is displayed in a representation, as shown in FIG. 2, on a user interface on a workstation computer, that is to say, by way of example, on a person computer used by a doctor in his consultation or treatment room. The input data items E, such as measured data items, e.g. ECG data, can be entered into the therapeutic information item 1 either manually or using conventional “drag and drop” techniques. It is also possible for a reference to the storage location of the input data items E to be entered instead of the actual input data items E.

When the therapeutic information item 1 is evaluated by the doctor or therapist, it is additionally possible to enter output data items A, e.g. in the form of a report M, from the data record DS for forwarding to other users, e.g. to a specialist doctor. This entry can be made automatically or manually, depending on the type and function of the output data items A. By way of example, the report M which is automatically sent may be an electronic message to a further doctor treating the same patient.

The or each input E is used to supply the therapeutic information item 1 with data items D, such as patient data items or information items, relating to medical examinations and/or therapeutic measures and thus relating to treatments 2 and/or diagnostic and/or therapeutic device/method/etc., directly or indirectly.

The treating medic, that is to say the doctor or therapist, can in this case enter the input data items E into the respective therapeutic information item 1 manually. Alternatively, the input data items E may also be transferred automatically from a medical appliance which is performing the examination. When the therapeutic information item 1 is applied automatically, the input data items E can then be used to generate output data items A which are then firstly also automatically entered into the therapeutic information item 1 and are secondly forwarded automatically in the form of a report M.

In addition, the medic can define manually definable input and/or output data items E and A in the data record DS, e.g. compilation of distribution lists for the users with an interest in a prescribed treatment 2n, of output data items A for prescribed input data items E, for example during documentation or for the purpose of forwarding an information item relating to his prescribed or already performed treatments 2n−1 and/or 2m−1. These freely definable input and output data items E, A are stored in the respective therapeutic information item 1 and can be forwarded to an institution (not shown in more detail) which operates a central database, for the purpose of archiving or documentation or else for the purpose of settling accounts with other institutions.

In addition, in the case of an electronic patient record which is distributed over a plurality of databases in various institutions, it is also possible to identify past treatments 2n−1 and/or 2m−1, such as examinations, therapeutic measures, diagnoses and therapeutic decisions, for the purpose of taking into account examination results U or symptoms S collected in the process in the course of subsequent treatments 2n+1 and/or 2m+1 or for the purpose of notifying affected users. Preferably, upon a new diagnosis, after every transfer to a doctor who is continuing treatment, upon every new entry into the patient record, at periodically recurring and hence at prescribed or prescribable, in particular equidistant, execution times or after every update for the patient record by new examination results U or therapeutic measures, and hence under time and/or event control, past treatments 2n−1 and/or 2m−1 are identified.

In this context, a new prescription for a future subsequent treatment 2n+1 and/or 2m+1, or a subsequent treatment 2n+1 and/or 2m+1 automatically identified on the basis of periodic data items D, involves a report M, for example in the form of an electronic message, being output, preferably automatically, as an output data item A to a further user, e.g. to a doctor associated with a previous treatment 2n−or 2m−1, to a laboratory or to an institute which has the task of collecting examination results.

In addition, entries may be made in a data record DS which are used to output the recorded examination results U to further users automatically at the prescribed time. First, by way of example, the examination result U for the annual measurement of internal eye pressure may be automatically sent to the diabetologist by the optician, if the diabetologist has likewise prescribed the measurement. As already described above, consecutive examinations of such chronological proximity which involve the same measurements being carried out are optimized in terms of a common time of execution, so that this examination is carried out only once.

In a further example, when a blood sample is to be examined, which is usually performed by an external laboratory, a note may automatically be associated and appended to indicate that, besides the person placing the order, e.g. the general practitioner, a different body, likewise requesting examination of a blood sample, e.g. a clinic doctor or a specialist doctor, is also sent the examination results U. In one particularly simple embodiment, instead of forwarding examination results U to the further requesting body, a report M is merely sent to indicate that the examination results U have been entered in the electronic patient record—the data record DS, this report being able to be accessed by this body.

Furthermore, to simplify the work processes for the respective patient, and also the fact that doctor's practices are often a large physical distance from one another, the respective patient's electronic patient record (=data record DS) can store, as further data items D, a list of users, e.g. a list of all treating doctors. In this case, these data items D are linked to information items which are of interest to the user in question, such as current examination results U. If one of the users, for example the general practitioner, now collects an examination result U, then the list of treating doctors and the information items associated with these doctors can automatically be used to forward the current examination result U to those users who likewise need these examination results U. Alternatively, the current examination results U may be stored centrally and retrieved by the respective doctor. In this context, a report M is sent to the doctor in question only when new examination results are recorded.

In another preferred embodiment, each periodically recurring treatment 2n and/or 2m is stored in a list containing a number of data items D (=basic data items). In this case, the basic data items stored in the data record DS associated with the therapeutic information item 1 are, by way of example, an interval between two treatments 2n and 2n+1 and/or 2m and 2m+1, the start and end of the overall succession of treatments 4, permitted deviations from the time of execution of the respective treatment 2n or 2m, e.g. the next time of execution is Apr. 1, 2003 with the additional information item no later than within the next four weeks. Expediently, the data items D are stored in the data record DS in structured and normalized or standardized form. To identify a subsequent treatment 2n+1 and/or 2m+1 from the periodicity criterion P, the data items D in this case are stored as standard in a form of short words, such as weekly, monthly, annually, etc., or with the specific time of execution.

Any of the aforementioned methods may be embodied in the form of a program. The program may be stored on a computer readable media and is adapted to perform any one of the aforementioned methods when run on a computer. Thus, the storage medium or computer readable medium, is adapted to store information and is adapted to interact with a data processing facility or computer to perform the method of any of the above mentioned embodiments.

The storage medium may be a built-in medium installed inside a computer main body or removable medium arranged so that it can be separated from the computer main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks;

media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for processing at least one of periodically recurring and consecutive treatments for a patient using a data record including therapeutic information items, the method comprising:
using therapeutic information items, stored in the data record, to identify at least one periodicity criterion which is used to ascertain a subsequent treatment.

2. The method as claimed in claim 1, wherein newly input therapeutic information items are used to identify at least one periodicity criterion.

3. The method as claimed in claim 1, wherein the periodicity criterion is used to ascertain an associated time of execution for the subsequent treatment.

4. The method as claimed in claim 1, wherein the respective associated periodicity criterion for at least one of periodically recurring and consecutive treatments is used to ascertain a common subsequent time of execution.

5. The method as claimed in claim 1, wherein at least one previous treatment and its associated therapeutic information items are ascertained for the subsequent treatment.

6. The method as claimed in claim 1, wherein requisite examination results associated with the subsequent treatment are ascertained for said treatment, the therapeutic information items being used to identify examination results which are previous to the previous treatment and correspond to the requisite examination results.

7. The method as claimed in claim 6, wherein, if requisite examination results are the same as previous corresponding examination results, the previous corresponding examination results are used instead of reascertaining requisite examination results.

8. The method as claimed in claim 1, wherein the subsequent treatment is used to output a report.

9. The method as claimed in claim 1, wherein the examination results required for the subsequent treatment are used to output a report.

10. The method as claimed in claim 1, wherein ascertained examination results for a treatment are used to output a report.

11. The method as claimed in claim 1, wherein the examination results required for the respective treatment are recorded at least one of locally and centrally.

12. The method as claimed in claim 11, wherein the examination results recorded for the treatment are stored at least one of locally and centrally.

13. The method as claimed in claim 1, wherein the respective treatment is assigned at least one user.

14. The method as claimed in claim 1, wherein the examination results ascertained for the respective treatment are forwarded.

15. The method as claimed in claim 1, wherein at least one of periodically recurring and consecutive treatments are stored in a memory.

16. The method as claimed in claim 15, wherein at least one of periodically recurring and consecutive treatments are assigned a number of basic data items.

17. The method as claimed in claim 16, wherein the basic data items stored are at least one of examination results, a time of execution and an execution period.

18. An apparatus for carrying out the method as claimed in claim 1, wherein at least one active software agent is provided which is used to examine a data record including therapeutic information items for at least one of periodically recurring and consecutive treatments on the basis of a periodicity criterion which, in turn, is used to ascertain a subsequent treatment.

19. A computer program product for carrying out the method as claimed in claim 1, comprising at least one active software agent used for examining a data record including therapeutic information items for at least one of periodically recurring and consecutive treatments on the basis of a periodicity criterion which, in turn, is used to ascertain a subsequent treatment.

20. The method as claimed in claim 1, wherein the subsequent treatment is used to output a report to a user of a previous treatment.

21. The method as claimed in claim 1, wherein the examination results required for the subsequent treatment are used to output a report to an institute which collects the examination results.

22. The method as claimed in claim 1, wherein ascertained examination results for a treatment are used to output a report when a threshold value for at least one examination result is at least one of exceeded and undershot.

23. The method as claimed in claim 1, wherein the respective treatment is assigned at least a treating doctor.

24. The method as claimed in claim 1, wherein the examination results ascertained for the respective treatment are forwarded to at least one of a user and an assigned user.

25. A method relating to at least one of periodically recurring and consecutive treatments for a patient using a data record including at least one therapeutic information item, the method comprising:
using the at least one therapeutic information item, stored in the data record, to identify at least one periodicity criterion; and
using the identified at least one periodicity criterion to ascertain a subsequent treatment.

26. An apparatus for carrying out the method as claimed in claim 25, wherein at least one active software agent is provided which is used to examine a data record including therapeutic information items for at least one of periodically recurring and consecutive treatments on the basis of a periodicity criterion which, in turn, is used to ascertain a subsequent treatment.

27. A computer program product for carrying out the method as claimed in claim 25, comprising at least one active software agent used for examining a data record including therapeutic information items for at least one of periodically recurring and consecutive treatments on the basis of a periodicity criterion which, in turn, is used to ascertain a subsequent treatment.

28. A program, adapted to perform the method of claim 1, when executed on a computer.

29. A computer readable medium, storing the program of claim 28.

30. A program, adapted to perform the method of claim 25, when executed on a computer.

31. A computer readable medium, storing the program of claim 30.

32. An apparatus relating to at least one of periodically recurring and consecutive treatments for a patient using a data record including at least one therapeutic information item, the method comprising:
means for using the at least one therapeutic information item, stored in the data record, to identify at least one periodicity criterion; and
means for using the identified at least one periodicity criterion to ascertain a subsequent treatment.
